(19) United States
(12) Patent Application Publication
(10) Pub. No.: US 2005/0097052 A1
(43) Pub. Date: May 5, 2005

(54) Distribution of media objects

(75) Inventors: Kari Systa, Tampere (FI); Alexander Davydov, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/698,346

(22) Filed: Oct. 31, 2003

(51) Int. Cl. G06F 17/60

(52) U.S. Cl. 705/51

(57) ABSTRACT

A method and system for controlled distribution of a package containing at least one media object by an electronic device, the package further comprising information indicative of the conditions in which the distribution of the package is allowed. This information is examined to determine whether the distribution of the package is allowed or not before the package is distributed by the electronic device. If it is determined that the distribution of the package is allowed, the package distribution is started. The invention also relates to a system in which the method is implemented, an electronic device comprising means for storing the package and means for distributing the package to another electronic device, a computer program product comprising machine executable steps for distributing a package by an electronic device, and a business method for distributing a package to an electronic device.

### FIELD OF THE INVENTION

The present invention relates to a method for distribution of a package containing at least one media object by an electronic device. The invention also relates to a system comprising means for transmitting a package containing at least one media object by an electronic device. The invention further relates to an electronic device comprising means for distributing a package containing at least one media object. The invention also relates to a computer program product comprising machine executable steps for distributing a package containing at least one media object. The invention further relates to a package containing at least one media object to be distributed by an electronic device. The invention further relates to a business method for distributing a package containing at least one media object.

### BACKGROUND OF THE INVENTION

At present there are numerous applications which are especially designed for mobile devices. In the designing of such applications the limitations have been taken into account to provide usable and user friendly applications for mobile devices. There have also been development projects for creating suitable platforms for utilising media objects in mobile devices. In the following, the so called Java 2Platform, Micro Edition is used as a non-restrictive example of such platforms.

The Java 2 Platform, Micro Edition is a Java platform for small, resource-constrained devices. The platform has complex internal structure and consists of configurations and profiles. A profile intended for such devices as mobile phones is called the Mobile Information Device Profile. Currently, there are two versions of the profile—MIDP 1.0 and MIDP 2.0. Java applications written for the MIDP are called MIDlets. For the purposes of transfer and installation at least MIDlets is packed into a Java Archive (JAR file). Java Archive is often referred to as a MIDlet suite. In the simplest case there is only one MIDlet in the MIDlet suite. A MIDlet suite can be accompanied by an Application Descriptor (JAD file). It is a file that contains short description of the JAR file.

The MIDP 2.0 is the next version of the MIDP. Among many enhancements, the MIDP 2.0 introduces a security framework where each installed MIDlet suite belongs to some security domain (e.g. manufacturer, operator, third-party, untrusted). A newly-installed MIDlet suite is authenticated to one of the domains available on the device. In order to make authentication possible the MIDlet suite should be signed, i.e. encrypted hash of the JAR file must be in the JAD file. This signature is verified during the installation of the MIDlet suite, to ensure that the content of the JAR file was not tampered. Only those MIDlet suites that are accompanied by JAD files can be installed as trusted (as the JAD file contains JAR's digital signature). If the MIDlet suite had no JAD file, or the JAD file does not contain the digital signature the suite is installed as untrusted.

Currently, distribution of MIDlet suites from the mobile device to other devices is undesirable. The reason for that is as follows: it is impossible to separate MIDlet suites that can be distributed, from MIDlet suites for which distribution must be prevented. As a result the transmission of MIDlet suite from the terminal should not be allowed. At the same time there are numerous MIDlet suites which potentially could be superdistributed from one mobile phone to another without infringement of anyone's copyright. This could be done in much the same fashion as business cards are exchanged nowadays.

The Open Mobile Alliance (OMA) has proposed a Digital Rights Management (DRM) concept. This general-purpose technology allows to execute control over consumption of any type of media objects—ringtones, wallpapers, and also MIDlet suites. Control is achieved by separation of a media object from rights to use this object. By formulating these usage rules media object providers can control consumption of media objects. The technology proposes two methods for delivery of rights and media objects: combined delivery and separate delivery. The latter method has a special case: superdistribution. In this delivery method an encrypted media object is distributed 100 from one mobile device 101 to another mobile device 102 (FIG. 1). To start using the media object the user of another mobile device 102 needs to contact the rights issuing service 103 somewhere in the network 104 and request 105 a rights object. The URL of the rights issuing service 103 comes with the encrypted media object. If rights to use the media object are granted, the rights object is pushed 107 through a push proxy gateway 106 to the another mobile device 102. It is used for decryption and the media object becomes available for usage.

OMA DRM superdistribution can be applied for distribution of MIDlets from one device 101 to another device 102.

However, OMA DRM superdistribution has its disadvantages when it comes to distribution of MIDlet suites for which the distribution is allowed. One drawback of using OMA DRM superdistribution is the following: to start using the MIDlet suite the new user needs to go over-the-air to obtain a rights object. Therefore, even though the rights object can be granted for free, OMA DRM superdistribution may cause additional costs, for example communication costs, to the user. As a result many users will ignore the method to avoid additional costs. The drawback for the content provider is the need to maintain its own rights issuing service or to have a business relation with the administrator of such service.

### SUMMARY OF THE INVENTION

The present invention provides a solution to allow controlled distribution of media objects e.g. applications, such as MIDP 2.0 trusted MIDlets, from one device to another. The invention is based on the idea that a tag indicative of the conditions in which the distribution of a package containing one or more media objects is allowed is included in a package containing the media object(s) and the package can be protected against unauthenticated modifications by, for example, a digital signature which is included in the package. The integrity of the package can then be checked before distributing the package to ensure that the tag is not tampered. This tag is checked before distributing the media object to determine if the distribution is allowed or not. One package may contain more than one media object.

According to one aspect of the present invention there is provided a method for distributing a package containing at least one media object by an electronic device, the package further comprising information indicative of the conditions in which the distribution of the package is allowed, wherein before the package is distributed by the electronic device said information indicative of the conditions in which the distribution of the package is allowed is examined to determine whether the distribution of the package is allowed or not, and if it is determined that the distribution of the package is allowed, the package distribution is started.

According to another aspect of the present invention there is provided a system for distributing a package containing at least one media object by an electronic device, the package further comprising information indicative of the conditions in which the distribution of the package is allowed, and the system comprising means for examining the information indicative of the conditions in which the distribution of the package is allowed to determine whether the distribution of the package is allowed or not, and means for distributing the package from the electronic device if it is determined that the distribution of the package is allowed.

According to a third aspect of the present invention there is provided an electronic device comprising means for distributing a package containing at least one media object, the package further comprising information indicative of the conditions in which the distribution of the package is allowed, and the electronic device comprising means for examining the information indicative of the conditions in which the distribution of the package is allowed to determine whether the distribution of the package is allowed or not, and means for distributing the package if it is determined that the distribution of the package is allowed.

According to a fourth aspect of the present invention there is provided a mobile communication device comprising means for distributing a package containing at least one media object, the package further comprising information indicative of the conditions in which the distribution of the package is allowed, and the mobile communication device comprising means for examining the information indicative of the conditions in which the distribution of the package is allowed to determine whether the distribution of the package is allowed or not, and means for distributing the package if it is determined that the distribution of the package is allowed

According to a fifth aspect of the present invention there is provided a computer program product comprising machine executable steps for distributing a package containing at least one media object by an electronic device, the package further comprising information indicative of the conditions in which the distribution of the package containing one or more media objects is allowed, wherein the computer program product further comprises machine executable steps for examining, before the package is distributed by the electronic device, the information indicative of the conditions in which the distribution of the package is allowed to determine whether the distribution of the package is allowed or not, and the computer program product comprising machine executable steps for distributing the package by the electronic device, if it is determined that the distribution of the package is allowed.

According to a sixth aspect of the present invention there is provided a package containing at least one media object to be distributed by a first electronic device, the package further comprising information indicative of the conditions in which the distribution of the package is allowed, wherein before the package is distributed from the electronic device the information indicative of the conditions in which the distribution of the package is allowed is examined to determine whether the distribution of the package is allowed or not, and if it is determined that the distribution of the package is allowed, the package distribution is started.

According to a seventh aspect of the present invention there is provided a business method for distributing a package containing at least one media object to an electronic device, the method comprising including information indicative of the conditions in which the distribution of the package is allowed. The invention has significant advantages. The invention provides quite a simple and easy to use method for providing, ensuring and distributing packages of media object(s). The media object providers can be quite sure that the packages according to the present invention can not be distributed under any other conditions than indicated in the package. The invention also provides a method for allowing an easy distribution of packages for which distribution is allowed and at the same time preventing distribution of packages for which distribution is not allowed if the condition(s) for the package distribution is/are not fulfilled. The distribution of the packages is possible without any connection to a communication network. Furthermore, to use the package in another device and further distribute it there is no need to separately obtain any rights object for the package.

### DESCRIPTION OF THE DRAWINGS

In the following the invention will be described in more detail with reference to the attached drawings, in which

FIG. 1 discloses a prior art method for distribution of a package from one device to another,

FIG. 2a discloses an embodiment of a package containing at least one media object according to the present invention,

FIG. 2b discloses another embodiment of a package containing at least one media object according to the present invention,

FIG. 3 discloses an embodiment of a system according to the present invention,

FIG. 4 discloses an embodiment of an electronic device according to the present invention,

FIG. 5a discloses a creation of a package according to the present invention as a flow diagram, and

FIG. 5b discloses a distribution of a package according to the present invention as a flow diagram.

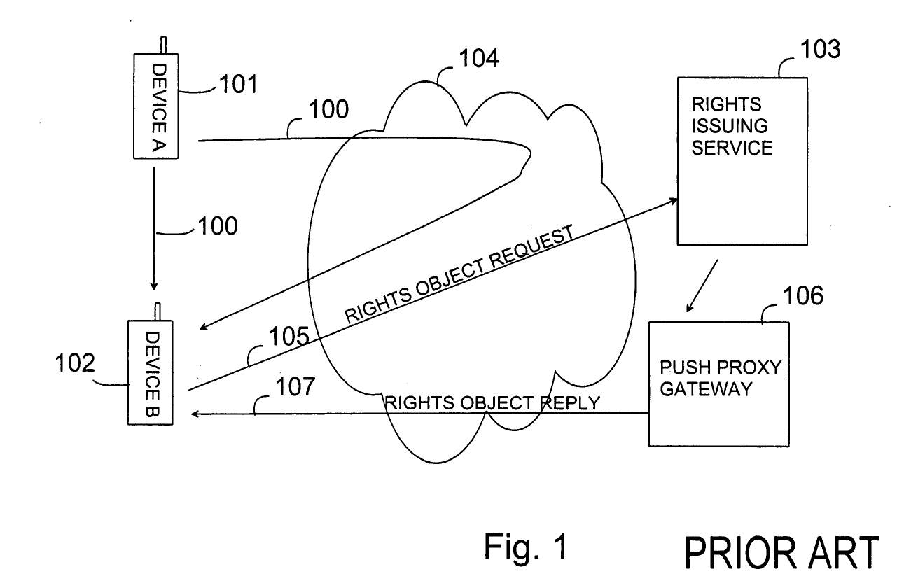

### DETAILED DESCRIPTION OF THE INVENTION

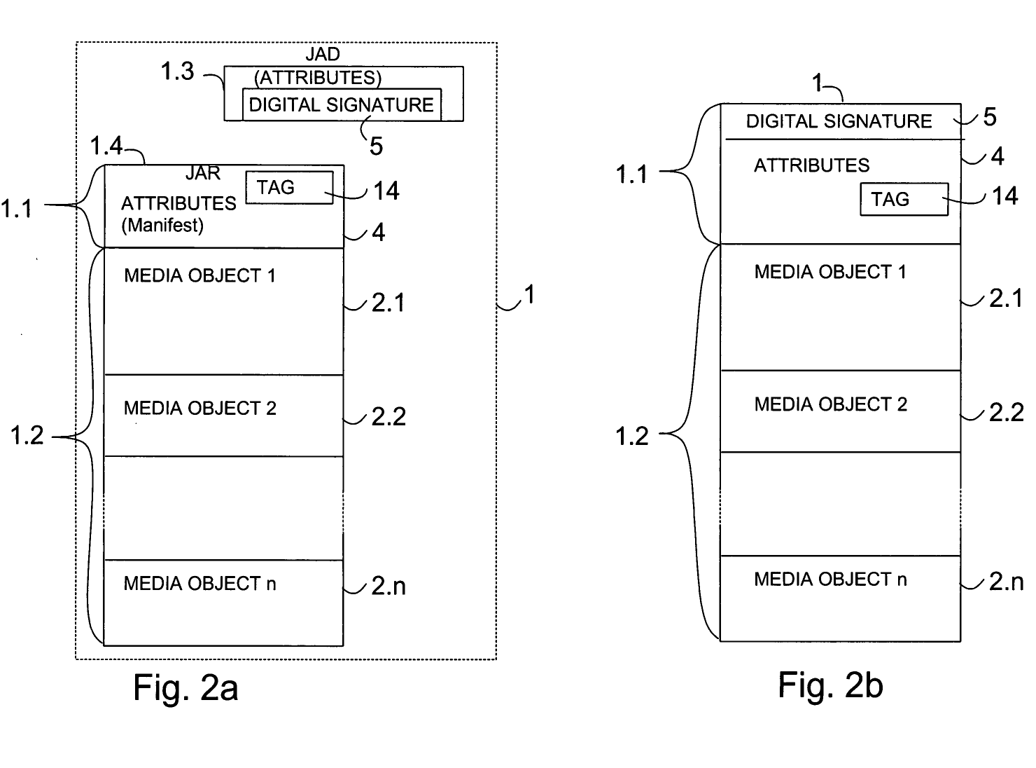

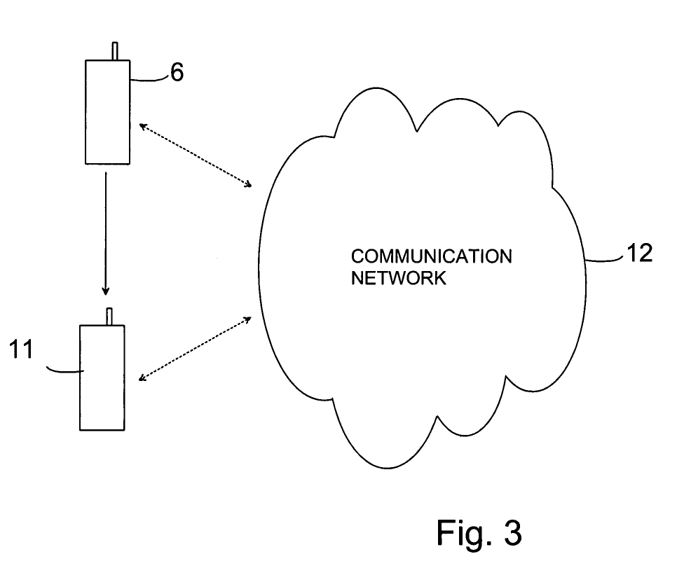

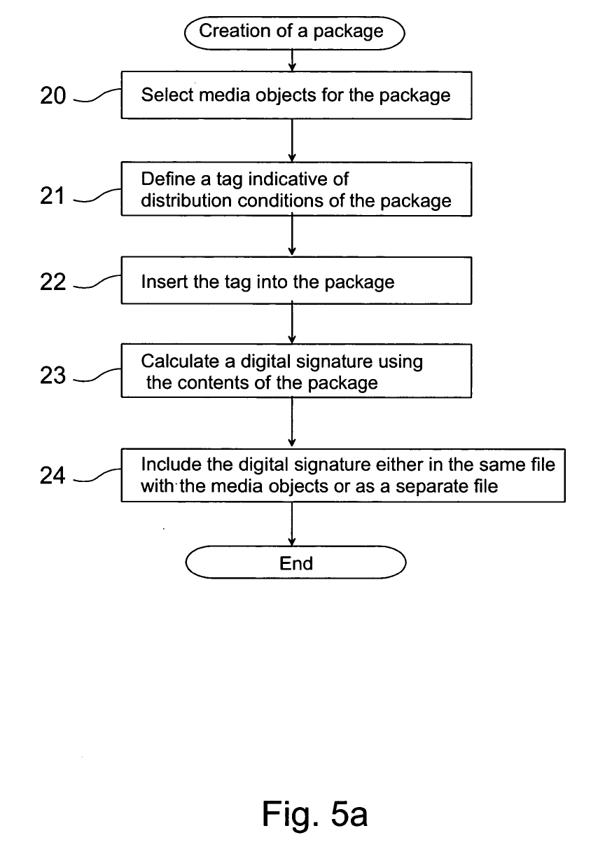

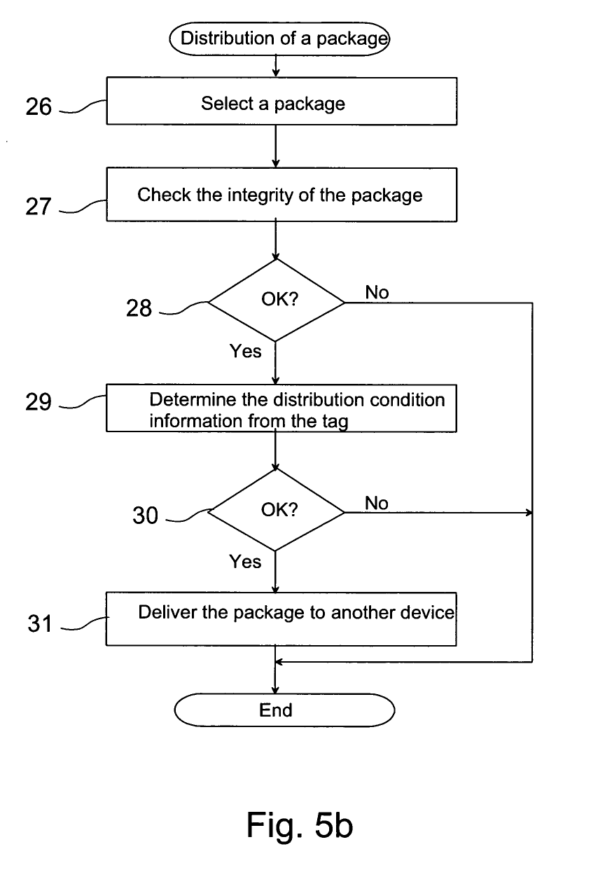

In FIG. 2a an embodiment of a package 1 according to the present invention is disclosed. In FIG. 5a an example method for the creation of the package 1 is disclosed as a flow diagram. The package 1 contains at least a header field 1.1 and a payload field 1.2. The payload field 1.2 comprises at least one media object 2.1, 2.2, . . . , 2.n the provider of the package has selected (block 20 in FIG. 5a) to be included in the package 1. At least one media object 2.1, 2.2, . . . , 2.n of the package 1 can be, for example, a ring tone, a wallpaper, a software program, a still image, a video clip, an audio clip, a text document, etc. In an embodiment of the present invention the package comprises a JAR file (JAVA Archive) and a JAD file according to MIDP specifications. It is obvious that the present invention is not limited to MIDP specifications, JAR files, or JAD files, but it can be applied with many different kinds of media objects and packages of media objects. The provider defines the conditions for the distribution of the package and stores 21 them as a tag 14. The header field 1.1 of the package 1 comprises an attribute section 4 in which the tag 14 is included 22. The purpose of the tag 14 is at least to control the distribution of the package 1 from one device to another as will be shown later in the description. The package 1 further comprises a signature field 5 containing a digital signature of the package or some other information which can be used to check the integrity of the tag and also other parts of the package. In one embodiment of the present invention the digital signature 5 is included in the JAD file. The digital signature is calculated 23 at least partly on the basis of the contents of the package by a digital signature algorithm, for example, using a hash algorithm known as such, and stored 24 as a part of the package 1. The digital signature can then be used to verify that the package and the tag 14 are exactly the same as they were created by the provider of the package. To ensure that the digital signature 5 also verifies the trustworthiness of information in the attribute section 4, the attribute section 4, or at least the tag 14, is included in the calculation of the digital signature 5. The package can be installed into an electronic device 6 (FIG. 3). When the package 1 contains two files 1.3, 1.4 both of them have to be installed in the electronic device 6 to allow the usage of the package 1.

In the MIDP package case there are actually two attribute sections. One is a separate file, called the JAD file, and the other is a Manifest, which is in the JAR file. In this case the attributes indicating rights for distribution i.e. the tag 14, are stored in the Manifest because then the tag 14 cannot be changed without causing the digital signature check to fail. The digital signature is stored in the JAD file.

The digital signature 5 can be used to check that the package is exactly the same as was created by the provider and that no one else but the verified origin has modified the tag or the package. The verified origin is the provider of the package or someone who is authorized by the provider of the package.

It is also possible that the digital signature 5 is arranged in the same file containing the header field 1.1 and at least one media object 2.1, 2.2, . . . , 2.n, as is shown in FIG. 2b. In that case the calculation of the digital signature is performed at least partly on the basis of the contents of the package 1, however excluding the part to which the digital signature 5 is to be stored. The digital signature 5 of the package is stored into the file after the calculation. The digital signature 5 is then examined to find out the trustworthiness of the file containing at least one media object 2.1, 2.2, . . . , 2.n of the package 1 and the attribute section including the tag 14.

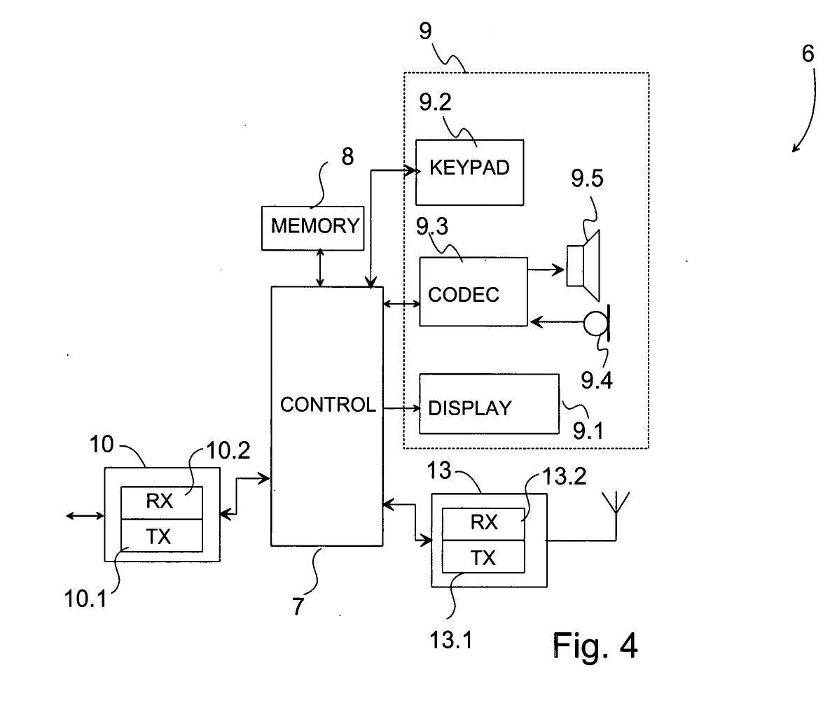

In FIG. 3 an embodiment of a system according to the present invention is disclosed and in FIG. 4 an embodiment of an electronic device 6 according to the present invention is disclosed. The electronic device 6 comprises at least one controller 7, for example a processor and/or a digital signal processor, for controlling the operations of the electronic device 6. The electronic device also comprises a memory 8 for storing program code and data. The memory is also used to store the packages 1 according to the present invention. In the electronic device of FIG. 4 there is also a user interface 9 for indicating information to a user of the electronic device 6 and/or enabling the user to input data, commands, etc. to the electronic device 6. The user interface 9 can comprise, for example, one or more displays 9.1, one or more keyboards 9.2 and audio means such as a codec 9.3, a microphone 9.4 and a loudspeaker/earphone 9.5 However, the present invention can also be implemented with electronic devices the user interface 9 of which includes less features than mentioned above. For example, the user interface of such an electronic device can comprise the display 9.1 but no keyboard 9.2; or the user interface can comprise the keyboard 9.2 and the audio means but no display 9.1; or the user interface can comprise the display 9.1 and the keyboard 9.2 but no audio means. It is also possible that the electronic device 6 comprises other input means than keyboard or microphone. For example, a so called touch panel can be used in addition to or instead of keyboard and/or microphone to input commands, data etc. The electronic device 6 can be, for example, a mobile communication device, a personal digital assistant device (PDA), a laptop computer, a tablet computer, etc.

The electronic device 6 is arranged to communicate with another electronic device 11 (FIG. 3) by first communication means 10 including, for example, a short range transmitter 10.1 and a short range receiver 10.2. The first communication means 10 are preferably wireless communication means using optical (e.g. infrared), magnetic, acoustic and/or radio waves (e.g. Bluetooth™) for local communication. However, it is obvious that the first communication means 10 can also use wired connection for communicating with another electronic device 11 or devices. It is also possible that the first communication means 10 of the electronic device 6 can comprise two or more different transmitter/receiver pairs for different kinds of local communication. The electronic device 6 of FIG. 4 is also arranged to communicate with a communication network 12 (FIG. 3) such as a mobile communication network, a LAN (Local Area Network), the internet, etc. For that purpose, the electronic device 6 comprises second communication means 13 comprising a long range transmitter 13.1 and a long range receiver 13.2 for communication with said communication network 12. Again, the implementation of the second communication means 13 depends on the communication network 12 with which the electronic device 6 is intended to communicate. It is also possible that the second communication means 13 of the electronic device 6 can comprise two or more different transmitter/receiver pairs for communication with different communication networks. It is also possible that the package distribution from the electronic device 6 to the other electronic device 11 is performed using not local but long distance communication, for example by using the second communication means 13.

In the following, the distribution method according to an embodiment of the present invention will be described in more detail with reference to the flow diagram in FIG. 5b. It is assumed that at least one package 1 according to an embodiment of the present invention is stored in the memory 8 of the electronic device 6. When the user of the electronic device 6 intends to distribute i.e. transmit the package 1 to another device 11, she/he uses the user interface 9 of the electronic device 6 to select (block 26 In FIG. 5b) the package 1 for distribution. After the selection the user may also input a command to start the transmission, or the transmission will be started automatically after the selection is performed. When the transmission is to be started the electronic device 6, for example by a program code of the controller 7, first examines 27 the integrity of the package, for example, by calculating the digital signature of the package, and comparing 28 the calculated digital signature with the digital signature of the package. If the check 28 indicated that the package 1 is not tampered, the tag 14 is examined 29 to find information indicative of conditions in which the distribution of the package 1 is allowed or is not allowed. The conditions may vary in different implementations and also the way in which the conditions are indicated may vary.

Distribution of the package 1 may depend on the date, the time of day, the identity of the electronic device 6 (device ID), the manufacturer of the device, the model or version of the device, the provider of the package, user subscription information, etc. It is also possible that the distribution of the package costs something and/or depends on the properties of the other device 11 and/or subscription information of the user of the other device 11 to which the package is intended to be transmitted. For the indication, a certain bit or group of bits of the attribute section 4 may be used. The attribute section contains, for example, a timestamp, wherein the transmission may be allowed only a short time before or after the date and time of the timestamp, or the transmission may be allowed in a certain time period, etc. The attribute section may also comprise condition information as a text, e.g., “Allow-Distribution: True”. The above mentioned examples are just for clarifying, not for limiting the invention.

If the distribution depends on one or more details of the other device 11 i.e. a receiving device, the electronic device 6 communicates with the other device 11 to exchange necessary information for determining whether the distribution is allowed or not.

If it is determined 30 that the transmission of the package 1 is allowed, the electronic device 6 starts to transmit 31 the package 1 to the other device 11 (i.e. the receiving device) or to more than one other device 11. The transmission can be performed by methods known as such. The transmission method may depend on the communication technique and/or protocol applied in the first communication means 10 and/or in the second communication means 13.

If the electronic device can be sure that the tag 14 containing information indicative of conditions in which the distribution of the package 1 is allowed or is not allowed is not modified, the checking of the integrity of the package 1 is not necessary.

It is also possible to implement the present invention without any validity checks of the package 1. In this kind of implementation only the tag is checked to determine whether the delivery of the package 1 is allowed or not. It should be noted here that the other device 11 may comprise similar functional blocks as the transmitting device 6. Therefore the functional blocks of the other device 11 are not shown in the figures.

When the package 1 is received it is stored in the memory reserved for storing such packages in the other device 11.

It should be noted here that, contrary to prior art methods, the distribution of the package 1 is possible without the need to establish a connection to the communication network 12 for obtaining the rights to use the package. Further, in some cases when the local communication means 10 are used, the transmission of the package does not normally cause any communication costs. In such cases the user has to pay only if the package is not free.

When the user of the other device 11 wants to use one or more of the media objects of the package 1, she/he selects them, for example, by user interface of the other device 11. On the basis of the selection the controller of the other device 11 starts to examine the header field to find the location(s) of the selected media object(s). When the media object(s) is/are found the controller performs necessary steps to activate the media object(s), for example, start to execute a software program, play a sound, play a video clip, paint a wallpaper etc.

If the other device 11 is able to verify that the received package 1 was not tampered and its distribution is allowed, it can forward it further to still another electronic device (not shown).

In a situation that the package 1 does not contain information about distribution conditions of the package, the package is not transmitted at all.

The above described invention provides quite a simple and easy to use method for providing, ensuring and distributing packages of media object(s). The media object providers can be quite sure that the packages according to the present invention can not be distributed under any other conditions than indicated in the package 1. The invention also provides a method for allowing easy distribution of packages for which distribution is allowed and at the same time preventing distribution of packages for which distribution is not allowed.

In a situation in which the package is not free, the attribute field preferably contains information about the cost of the package and the payment method. Information is indicated to the user by the user interface 9 of the electronic device so that the user can get information on how to pay for the package and get the package delivered to the other device 11.

It is also possible to use other methods than the digital signature to assure the integrity of the package 1 and the trustworthiness of the tag 14. For example, the electronic device 6 may be constructed so that the operating system and/or other software of the electronic device 6 prevents the modification of the package 1 and/or the tag 14 of the package. Hence, after the package 1 is installed into the electronic device 6 it is not possible to change the value of the tag 14. The protection against modifications of the tag 14 can also be based on hardware. At the same time the transmission system may also be constructed so that the it prevents the modification of the package 1 and/or the tag 14 of the package.

It is obvious that the present invention is not limited to the above described embodiments but it can be varied within the scope of the attached claims.

1. A method for distribution of a package containing at least one media object by an electronic device, the package further comprising information indicative of the conditions in which the distribution of the package is allowed, wherein before the package is distributed by the electronic device an examination is performed to examine said information indicative of the conditions in which the distribution of the package is allowed to determine whether the distribution of the package is allowed or not.

2. The method according to claim 1, wherein before the examination a check is performed to verify the integrity of the information indicative of the conditions in which the distribution of the package is allowed, and if the verification of the integrity of the package fails, the distribution is prohibited.

3. The method according to claim 1, wherein said package is distributed to another electronic device.

4. The method according to claim 1, wherein said information indicative of the conditions in which the distribution of the package is allowed and the at least one media object are stored in the same file.

5. The method according to claim 1, wherein said information indicative of the conditions in which the distribution of the package is allowed and the at least one media object are stored in different files.

6. The method according to claim 1, wherein said information indicative of the conditions in which the distribution of the package is allowed is protected by a digital signature.

7. The method according to claim 1, wherein a software is executed in the electronic device for controlling the handling of the package, and the modification of the package is prevented by said software.

8. The method according to claim 3 comprising at least the steps of:
storing at least one package into a memory of the electronic device,
selecting a package from the memory for distribution to the other electronic device,
verifying the integrity of the package,
examining said information indicative of conditions in which the distribution of the package is allowed or is not allowed to determine if the package can be transmitted or not, and
on the basis of said examining either transmitting the selected package to the other electronic device, if it is determined that the transmission is allowed, or not transmitting the selected package to the other electronic device, if it is determined that the transmission is not allowed.

9. The method according to claim 3, said information indicative of conditions in which the distribution of the package is allowed or is not allowed comprising at least one detail of the other electronic device, wherein the electronic device communicating with the other device exchanges information on said at least one detail of the other device for determining whether the distribution is allowed or not.

10. The method according to claim 1, said information indicative of conditions in which the distribution of the package is allowed or is not allowed comprising information about the cost of the package and the payment method.

11. A system for distributing a package containing at least one media object by an electronic device, the package further comprising information indicative of the conditions in which the distribution of the package is allowed, and the system comprising means for examining the information indicative of the conditions in which the distribution of the package is allowed to determine whether the distribution of the package is allowed or not, and means for distributing the package by the electronic device if it is determined that the distribution of the package is allowed.

12. The system according to claim 11 comprising verification means for verifying the integrity of the package before examining the information indicative of the conditions in which the distribution of the package is allowed, and means for prohibiting the distribution of the package if the verification of the integrity of the package fails.

13. The system according to claim 11 comprising means for distributing said package from the electronic device to another electronic device.

14. The system according to claim 11, wherein said information indicative of the conditions in which the distribution of the package is allowed and the at least one media object are stored in the same file.

15. The system according to claim 11, wherein said information indicative of the conditions in which the distribution of the package is allowed and the at least one media object are stored in different files.

16. The system according to claim 13 comprising:
a memory in the electronic device for storing at least one package,
means in the electronic device for selecting a package from the memory for distribution to the other electronic device,
means in the electronic device for verifying the integrity of the package,
means in the electronic device for examining said information indicative of conditions in which the distribution of the package is allowed or is not allowed to determine if the package can be transmitted or not,
means in the electronic device for transmitting the selected package to the other electronic device, if it is determined that the transmission is allowed, and
means in the other electronic device for receiving the selected package from the electronic device.

17. The system according to claim 13, said information indicative of conditions in which the distribution of the package is allowed or is not allowed comprising at least one detail of the other electronic device, wherein the system further comprising a transmitter and a receiver in the electronic device and in the other electronic device for exchanging information on said at least one detail of the other electronic device for determining in the electronic device whether the distribution is allowed or not.

18. The system according to claim 11, wherein said information indicative of conditions in which the distribution of the package is allowed or is not allowed comprises information about the cost of the package and the payment method.

19. An electronic device comprising means for distributing a package containing at least one media object, the package further comprising information indicative of the conditions in which the distribution of the package is allowed, and the electronic device comprising means for examining the information indicative of the conditions in which the distribution of the package is allowed to determine whether the distribution of the package is allowed or not, and means for distributing the package if it is determined that the distribution of the package is allowed.

20. The electronic device according to claim 19 comprising verification means for verifying the integrity of the package, and means for prohibiting the distribution of the package if the verification of the integrity of the package fails.

21. The electronic device according to claim 20, wherein in the package said information indicative of the conditions in which the distribution of the package is allowed is protected by a digital signature calculated on the basis of information of the package, wherein the means for verifying the integrity of the package comprise means for calculating a digital signature on the basis of information of the package and for comparing said digital signature of the package with said calculated digital signature to verify the integrity of the package.

22. The electronic device according to claim 19, wherein said information indicative of the conditions in which the distribution of the package is allowed and the at least one media object are stored in the same file.

23. The electronic device according to claim 19, wherein said information indicative of the conditions in which the distribution of the package is allowed and the at least one media object are stored in different files.

24. The electronic device according to claim 19 comprising means for preventing modifying the package.

25. The electronic device according to claim 19 comprising:
a memory for storing at least one package,
means for selecting a package from the memory for distribution to another electronic device,
means for verifying the integrity of the package,
means for examining said information indicative of conditions in which the distribution of the package is allowed or is not allowed to determine if the package can be transmitted or not, and
means for transmitting the selected package to the other electronic device, if it is determined that the transmission is allowed.

26. The electronic device according to claim 25, said means for selecting a package comprising means for indicating to a user of the electronic device information on packages for which distribution is allowed.

27. The electronic device according to claim 19, said information indicative of conditions in which the distribution of the package is allowed or is not allowed comprising at least one detail of another electronic device, wherein the electronic device further comprising a transmitter and a receiver for exchanging information on said at least one detail of the other electronic device for determining in the electronic device whether the distribution is allowed or not.

28. The electronic device according to claim 19, wherein said information indicative of conditions in which the distribution of the package is allowed or is not allowed comprises information about the cost of the package and the payment method, wherein the electronic device comprises means for indicating information on the cost and payment method to a user of the electronic device.

29. A mobile communication device comprising means for distributing a package containing at least one media object, the package further comprising information indicative of the conditions in which the distribution of the package is allowed, and the mobile communication device comprises means for examining the information indicative of the conditions in which the distribution of the package is allowed to determine whether the distribution of the package is allowed or not, and means for distributing the package if it is determined that the distribution of the package is allowed.

30. The mobile communication device according to claim 29 comprising means for verifying the integrity of the package.

31. A computer program product comprising machine executable steps for distributing a package containing at least one media object by an electronic device, the package further comprising information indicative of the conditions in which the distribution of the package is allowed, wherein the computer program product further comprises machine executable steps for examining, before the package is distributed by the electronic device, said information indicative of the conditions in which the distribution of the package is allowed to determine whether the distribution of the package is allowed or not, and the computer program product comprising machine executable steps for distributing the package by the first electronic device, if it is determined that the distribution of the package is allowed.

32. The computer program product according to claim 25 comprising machine executable steps for:
storing at least one package into a memory of the electronic device,
selecting a package from the memory for distribution to the other electronic device,
verifying the integrity of the package,
examining information indicative of conditions in which the distribution of the package is allowed or is not allowed to determine if the package can be transmitted or not, and
on the basis of said examining either transmitting the selected package to the other electronic device, if it is determined that the transmission is allowed, or not transmitting the selected package to the other electronic device, if it is determined that the transmission is not allowed.

33. A package containing at least one media object to be distributed by an electronic device, the package further comprising information indicative of the conditions in which the distribution of the package is allowed, wherein before the package is distributed from the electronic device said information indicative of the conditions in which the distribution of the package is allowed is examined to determine whether the distribution of the package is allowed or not, and if it is determined that the distribution of the package is allowed, the package distribution is started.

34. The package according to claim 33, wherein said information indicative of the conditions in which the distribution of the package is allowed is protected by a digital signature.

35. The package according to claim 33, wherein said information indicative of the conditions in which the distribution of the package is allowed and the at least one media object are stored in the same file.

36. The package according to claim 33, wherein said information indicative of the conditions in which the distribution of the package and the at least one media object are stored in different files.

37. The package according to claim 33, wherein the package comprises a digital signature formed on the basis of said information indicative of the conditions in which the distribution of the package is allowed and the at least one media object.

38. The package according to claim 33, wherein it is a Java archive.

39. The package according to claim 33 comprising a Java Archive and Application Descriptor.

40. The package according to claim 27, said information indicative of conditions in which the distribution of the package is allowed or is not allowed comprising at least one of the following:
date,
time of day,
identity of the electronic device,
identity of the other electronic device,
manufacturer of the electronic device,
manufacturer of the other electronic device,
model or version of the electronic device,
model or version of the other electronic device,
manufacturer of the package,
user subscription information
at least one other detail of the other electronic device.

41. A business method for distributing a package containing at least one media object to an electronic device, the method comprising including information indicative of the conditions in which the distribution of the package is allowed.

42. The business method according to claim 41 further comprising the steps of:
selecting a package from the memory for distribution to the other electronic device,
verifying the integrity of the package,
examining the information indicative of conditions in which the distribution of the package is allowed or is not allowed to determine if the package can be transmitted or not, and
on the basis of said examining either transmitting the selected package to the other electronic device, if it is determined that the transmission is allowed, or not transmitting the selected package to the other electronic device, if it is determined that the transmission is not allowed.

43. The business method according to claim 41, said information indicative of conditions in which the distribution of the package is allowed or is not allowed comprising information about the cost of the package and the payment method, wherein the business method further comprising steps of:
informing a user of the electronic device on the cost and payment method,
and performing the payment of the cost of the package.
